(19) United States
(12) Patent Application Publication
(10) Pub. No.: US 2005/0042023 A1
(43) Pub. Date: Feb. 24, 2005

(54) Structural assemblies using integrally molded, and welded mechanically locking z-pins

(76) Inventor: Steve R. Jones, Newbury Park, CA (US)

Correspondence Address: STETINA BRUNDA GARRED & BRUCKER, 75 ENTERPRISE, SUITE 250, ALISO VIEJO, CA, 92656, US

(21) Appl. No.: 10/644,424

(22) Filed: Aug. 20, 2003

(51) Int. Cl. F16B 5/00

(52) U.S. Cl. 403/267

(57) ABSTRACT

A structure is provided which includes first and second layers. The first and second layers are attached to each other by embedding or otherwise attaching at least one mechanically locking z pin to the first layer and then subsequently joining the protruding portion of the z pin to the second layer prior to the second layer being processed to a fully cured state. Alternatively, the z pin material is injected into a cavity formed in the first and second layer and then brought to a fully cured state. The z pin may have physical characteristics such as orientation, melting point and hardness as a function of the physical characteristics of the first and second layer and the forces subjected upon the first and second layers. For example, the z pin may define a longitudinal axis and be embedded within the first and second layers in alignment with an applied force subjected on the first and second layers. This ensures that the z-pin is subjected primarily to tensile forces which allows designs to better control the failure mode of the attached first and second layers.

### STATEMENT RE: FEDERALLY SPONSORED RESEARCH/DEVELOPMENT

The U.S. Government has a paid-up license in this invention and the right in limited circumstances to require the patent owner to license others on reasonable terms as provided for by the terms of FA-18E/F N00019-99-C-1226.

### CROSS-REFERENCE TO RELATED APPLICATIONS

Not Applicable

### BACKGROUND OF THE INVENTION

The present invention relates generally to attachment of two or more layers, and more particularly, to attachment of the layers using mechanically locking z-pins. The layers may be molded, cast, rolled, extruded, forged, machined or otherwise fabricated non-metallic or metallic layers, joined together with z-pins, which may be uniquely oriented in relation to an applied force, uniquely positioned within the attached layers, and have selectively unique material characteristics in relation to the attached layers.

Generally, three methods of permanently attaching two or more layers of metal, thermoset or thermoplastic composite, ceramic, specialty materials, or combinations thereof, to each other are available. The first method, bonding, includes co-curing, co-curing with adhesive, or simply adhesive bonding. Organic and non-organic based resin/fiber matrix components may be joined together by all the mentioned processes. Metallic layers, or combinations of metallic and non-metallic layers, can be joined by adhesive bonding.

Resin matrix composites joined using these methods include systems containing glass, boron, carbon, graphite, alumina, silicone carbide, quartz, aramid, ultra high molecular weight polyethylene and similar reinforcement fibers embedded in an organic thermoset (e.g., epoxy, polyester, polyimide, bismaleimide), or thermoplastic (e.g., polyethylene, HDPE, UHDPE) matrix, or a non-organic silicone based resin system. Prior art discusses these processes, and further describes advantages offered by varying geometric sections of the adherends by tapering, which essentially allow enhanced control of load transfer. Co-curing without adhesive does not allow material property variation at the joint. Co-curing with adhesive bonding, introduces an additional material to the joint, thereby allowing further control of joint behavior, by providing greater variability of stress distribution at the joint. For example, adhesive bonding allows joint behavior modification by introducing ductile materials to the joint. Addition of ductile material provides greater capability to react or control out-of-plane forces, sometimes referred to as peel stress. Adhesive bonding provides additional utility by allowing wider ranges of materials to be joined. Materials with similar characteristics, as well as those with substantially different characteristics, can be joined by adhesive bonding. Examples include metal to metal, metal to composite, metal or composite to specialty material having thermal, acoustic, vibro-acoustic, electric, or similar unique beneficial properties, can all successfully be joined using this method.

The second method is welding. Welding is used in joining both thermoplastic and metallic components. Thermoplastic components, as with metal components, are welded by applying sufficient heat to melt weld rod and parent material, and then allowing the materials to resolidify. Another common practice used in welding thermoplastic materials is ultrasonic welding, in which rapidly vibrating horns focus or direct energy to specially designed joints. Solvent welding uses solvents that dissolves or liquefy the polymer chains prior to evaporation or addition, and reconversion. Welding of thermoplastics at this time is not a commonly used method to create highly loaded structural joints.

The third method consists of embedding z pins within multiple composite layers. This method can include co-curing and co-curing with adhesive bonding. It is used to provide an enhanced mechanism to transfer out-of-plane loads between joined layers. Z-pins are driven into multiple composite layers by a variety of methods including hand held ultrasonic guns, pressure applied by vacuum bags and rubber blocks, and various other methods disclosed in prior art. Ultrasonic guns vibrate, at high frequency, driving the constant diameter z-pins into position. These hand held ultrasonic guns, however, are suspected of having ergonomic, environmental, and consolidation shortfalls. Hand held guns may lead to matrix discontinuities in the joint by locally initiating early cross linking and curing between the molecular chains that comprise the matrix. This premature partial curing occurs from operator induced variations of both dwell time and angular orientation, and non-operator influenced factors such as energy reflection from the tool surface. Automated insertion is presently being developed to reduce human exposure to these health and safety factors, limit exposure of the resin matrix to these variations in local energy density, and improve economic efficiencies.

All these solutions, co-curing, adhesive bonding, welding, and constant diameter z-pins, have their advantages, some of which are discussed above. However, these solutions also have disadvantages. In particular, adhesive bonding and co-curing provide the advantage of a minimal weight solution. But, these methods also have disadvantages, including low reliability, since the joined layers frequently, unpredictably and unknowingly become detached either by bond failure or delamination in at least one of the adherends. These failures are sometimes linked to displacements at the distal ends of the adherends, where local stresses resulting from these displacements, cause non-linear behavior of the adherend matrix, adhesive, or both. In the case of ductile metallic adherends, local plastic hinges may develop leading to permanent deformation. With more brittle materials, such as resin based composite matrices, delamination of the adherend or fracture of the bond surface are the usual result. Conventional joint analysis allows for these inelastic regions by reducing the effective bond area to exclude these inelastic zones. Conventional bond theory also recommends driving failure mechanisms into the adherends, which as stated above, result in either brittle or ductile failure depending upon the nature of the adherend material. The constant diameter z-pin was introduced to reduce these disadvantages. Simply stated, the mechanism by which constant diameter z-pins increase the bonded joint reliability, occurs by a transfer of higher out of plane or transverse loads from the matrix into the z-pins, across the adhesive bonded or co-cured interface, and then releasing the loads into the opposite adherend. But, due to the geometry of the constant diameter z-pins, reliability was only slightly improved. Forces not specifically aligned with the longitudinal axis of the z-pin, or forces exceeding the strength of the bond between the constant diameter z-pin and the resin matrix, cause bond failures between the laminates and the z-pins. The constant diameter deficiency allows only marginal improvement of out of plane load transfer. At relatively low load levels, local failures of individual bonds between the matrix and the constant diameter z-pin are arrested by the plurality of pins. However, in environments containing higher loads, combined with multiple cycle repetition, successive z-pin to matrix bond failures occur. When sufficient numbers of individual bond failures occur, catastrophic joint failure results.

U.S. Pat. No. 6,514,593 titled MECHANICALLY LOCKING Z-PINS (hereinafter referred to as the '593 Patent) was directed at further improving the reliability of attaching two or more composite layers with z-pins. The z-pins of the '593 Patent improved on the prior art by forming at least two flange sections with enlarged diameters at or near the distal ends. The '593 Patent also provided for variation in diameter between and around the flange sections. At least one flange section was embedded within the first layer, and at least one flange section was embedded within one or more of the successive layers to be joined. The enlarged diameter of the flange effectively increased the reliability of the bond between the attached composite layers through a physical locking of the flange section in the first and second layer. Another benefit of the '593 Patent is the increase in bond area between the '593 Patent z-pin and the layers. However, the z-pins disclosed in the '593 Patent, when inserted perpendicular to the adherends was still incapable of reacting large complex out of plane forces such as the bending and torsion loads that occur at highly loaded joints. In other words, the bond reliability of the two attached composite layers with the z-pins disclosed in the '593 Patent was still limited at reacting out of plane applied forces with a vector direction not aligned with the longitudinal axis of the '593 Patent z-pin. Moreover, the invention disclosed in the '593 Patent was directed to composite layers and not to non-composite layers, or combinations thereof. Therefore, deficiencies in attaching two composite or metal layers, or combinations thereof, were only partially solved. Failure of the joint may still occur by delamination of at least one of the layers because complex forces can fracture the bond between the '593 Patent z-pin and the matrix, leaving only the locking mechanism of the '593 Patent z-pin as the mode preventing layer separation. Additionally, attaching composite layers to non-composite layers, such as metal castings, injection molded plastics, thermal or electrical insulators or conductors, vibro-acoustic dampers, and other specialty materials was not specifically addressed.

The present invention is directed at solving the problems associated with attaching not only composite layers but also the non-composite layers described above. Moreover, the present invention is directed at providing better methods to control the failure mode of attached layers by allowing novel combinations of materials to be joined. To achieve these results, as described below, the present invention provides '593 Patent z-pins that are uniquely positioned within the layers, uniquely oriented in relation to an applied force, and possess a selectively unique material characteristics in relation to the two or more layers to be subsequently joined.

### BRIEF SUMMARY OF THE INVENTION

In accordance with the present invention, two or more layers may be attached to each other with the '593 Patent z-pins. The first layer may contain embedded or welded '593 Patent z-pins in either a metallic casting, a partially cured “B staged” consolidated part, a fully cured resin transfer molded (RTM) part, a formed extrusion or rolled section, or many other specialty materials. This first layer containing integrally molded or welded '593 Patent z-pins may then be subsequently joined to at least one additional layer. This secondary joining can take the form of uncured laminate being placed around the protruding '593 Patent z-pins, consolidated using pressure or other means, and cured. The secondary joining can also occur by inserting the first component with embedded '593 Patent z-pins into a fixture or tool and then injecting foam insulation or other previously noted materials into a cavity formed between the tool and the first layer. The secondary joining can occur by allowing a thermoplastic sheet exposed to heat, pressure or combinations therof to form or drape over the protruding '593 Patent z-pins. Many other such combinations of materials and processes are feasible. End item components joined in the fashion provide structural sub-assemblies or major assemblies of an airplane fuselage or a boat hull. A non-aerospace example of functionality is the '593 Patent z-pins being welded, by frictional rotational welding or other technique, to rolled mild steel beam or column sections used in building construction. These sections may later be embedded in grout or reinforced concrete, which when cured locks the '593 Patent z-pins into the matrix, thereby creating an integrated structure. Another aerospace and marine application occurs by welding the pins to formed extrusions used in ship or aircraft construction followed by a subsequent final cure to composite laminates. These examples illustrate a few of the wide range of applications to which the present invention provides novel solutions. Economics of each application require evaluation, likely restricting the majority of applications to industries routinely incorporating higher dollar per pound applications, i.e., satellites, missiles, aircraft, marine and automotive.

One unique aspect of the present invention is the capability to precisely position and orient the '593 Patent z-pins within the two layers. This capability overcomes deficiencies of the prior art as discussed in the background of the invention. For example, a '593 Patent z-pin having at least two radially extending flange sections may have at least one flange embedded in the first layers by physical consolidation processes, casting, RTM, or other similar operation and at least one exposed flange which is subsequently covered with uncured prepreg, speciality material, or lower temperature melting metal alloy creating a single integral subassembly. The second or subsequent layers may be thermal or acoustic insulation material, molten metal, injection molded plastic, various other materials, or combinations thereof. The respective flange sections may be embedded within respective first and second layers to a depth equal to the width of the section or have the flanges embedded at the outer surface of either the first or second layer, or both. In this way, a pull out force of the '593 Patent z-pin in relation to the first and second layers may be increased to a level greater than the yield strength or ultimate strength of the '593 Patent z-pin itself. This capability to vary depth, flange width, and angular adjustment allows the pull out force to be greater than the ultimate tensile strength of the base '593 Patent z-pin diameter, thereby allowing the failure mode to be in the z-pin at that location. Conversely, design considerations may dictate the desired failure mode to occur in one of the layers. In the case of materiel subjected to high velocity impact, especially at low temperatures, this unique capability may prevent un-zipping type catastrophic failures caused by brittle fracture of a bond line. Furthermore, since the embedded '593 Patent z-pin can locally and individually absorb energy, damage zones may be restricted.

The relationship between the pull out force and the strength of the z-pins which are embedded in respective first and second layers may be adjusted by increasing the number or diameter of flange sections, the diameter of the pin between flanges, or combinations thereof. For example, if the first layer has a strength lower than the second layer then the first layer may have more flange sections, or flange sections with larger diameters, or combinations thereof, embedded therein, to better equate the pull out force of the z-pin from the first layer to the pull out force of the z-pin from the second layer. Thereafter, if a determination is made that the pull out forces of the '593 Patent z-pin from the first and second layers is lower than the strength of the z-pin, then additional or larger diameter flange sections may be embedded within respective first and second layers to increase the pull out forces of the z-pin from the respective first and second layers to a level greater than the strength of the z-pin. In this regard, the failure mode or detachment of the two layers may be controlled such that the z-pins will fail prior to delamination of the first and second layers. Additionally, the failure mode can be directed to a sacrificial or non-critical layer. Thus, ablative materials can be embedded around the '593 Patent z-pin and replenished as part of scheduled land base maintenance operations.

In another aspect of the present invention, a longitudinal axis of the z-pin may be aligned with an applied force which acts upon the attached layers. For example, if the direction of the applied force is angled seventy degrees from the interface surfaces of the first and second layers, then the preferable orientation of the longitudinal axis of the z-pins is seventy degrees from the interface surfaces. In this regard, the applied force may act upon the z-pins primarily in a tensile direction to thereby reduce stress concentrations that may result from the z-pin at the interface surfaces of the first and second layers. The following example will better illustrate the reason for stress concentrations at the interface surfaces of the first and second layer when the longitudinal axes of the z-pins are not aligned with the applied force. In particular, if the above example was altered such that the longitudinal axis of the z-pins were perpendicular to the interface surfaces of the first and second layer then the applied force may create not only a tensile load on the z-pins but additionally a moment on the z-pin. This moment may bend or flex the z-pins so as to create a deformity at a diameter of the z-pin located at the interface surfaces of the first and second layers. The deformity of the diameter of the z-pin may be an expansion or contraction depending on the location about the diameter to thereby press up against the interface surfaces of the first and second layers. In sum, aligning the longitudinal axis of the z-pin with the applied force may reduce the stress concentration between the z-pin and the interface surfaces of the first and second layer which accordingly increases the ability to control the reliability of the failure mode of the joint, first, and second layers.

In another aspect of the present invention, the materials the z-pins are manufactured from may be chosen as a function of the material from which the first and second layers are manufactured. For example, the coefficient of thermal expansion (CTE) of the z-pin may be less than or equal to the CTE of the first and second layers. In this situation, when the CTEs are equal to each other, the physical dimensions of the z-pins may expand or contract in one-to-one proportion with respect to the physical dimensions of the first and second layers, and more particularly, may expand or contract in one to one relationship with mating surfaces which receive the z-pins. The first and second layers define the mating surfaces as a depression which are sized and configured to receive the z-pins. In this regard, as flange sections of the z-pins expand as the layers and z-pins are heated, the respective mating surfaces which receive that particular z-pin may appropriately expand. As such, the pressure between the flange sections and the mating surfaces may remain constant as the attached two layers are cycled through a heat and cool cycle. In the situation where the axial or longitudinal CTE of the z-pin is less than the z direction CTE of the first and second layers, the attached layers may expand at a greater rate compared to the z-pin. In this case, the pressure at the joint mating surface is increased as the combined first and second layers with embedded z-pins are heated, and decreased as the temperature of the first and second layers is reduced. In sum, the unique relationship between the CTE of the z-pin and the CTE of the first and second layers provide the specific advantage of allowing the control of joint interface pressure by maintaining, increasing or decreasing the initial pressure therebetween.

In another aspect of the present invention, the first and second layers may have disposed therebetween a strip. In this embodiment, at least one z-pin may be embedded within the first layer, and at least one z-pin may be embedded within the second layer. Thereafter, the z-pins embedded within the respective first and second layers are embedded into the strip. The thickness of the strip may be a function of the amount that the z-pin protrudes from the respective first and second layers. In a situation where the z-pins embedded within the first layer are in alignment with the z-pins embedded within the second layer, the thickness of the strip may be equal to or greater than the sum of the protruding portion of the z-pins embedded within the first layer and the protruding portion of the z-pins embedded within the second layer. To reduce the thickness of the strip, the z-pins embedded within the first layer may be offset with relation to the z-pins embedded within the second layer. Additionally, the z-pins embedded within the first and second layers may be spaced such that the z-pins embedded within the first layer may be interposed between the z-pins embedded within the second layer. In this regard, the thickness of the strip may be reduced to approximately half of the thickness of the strip where the z-pins within the first and second layers are aligned and not offset.

In another embodiment of the present invention, the first layer may have a depression sized and configured similarly to a corresponding flange section formed on the second layer. The second layer may have a nub formed on the interface surface similarly to a flange section of the z-pin. Additionally, the nub and the second layer may be manufactured at a unitary unit. Thereafter, the nub may be embedded within the depression of the first layer. The unitary nature of the nub and the second layer provides an additional or specific advantage of controlling the failure mode between the first and second layers. For example, the pull out force of the nub from the depression of the first layer may be less than a delamination force required to break off the nubs from the second layer. In this regard, the failure of the attachment between the first and second layers may be controlled such that the failure occurs in the first layer. Hence, the first layer may be designed as a replaceable layer, whereas the second layer may be designed as a sturdy non-replaceable second layer. This concept of making one of two parts a replaceable part is similar to a screw and screw hole design where failure is preferably at the threads of the screw instead of the threads of the screw hole because replacing a screw is easier and less costly compared to replacing the structure the screw hole is formed.

The concept of positioning, aligning, and selectively choosing various materials in relation to the above described aspects of the present invention wherein the z-pins are separate identifiable components with respect to the first and second layers may also be imported or applied to the above described aspects of the present invention where nubs are unitarily formed with the second layer.

### BRIEF DESCRIPTION OF THE DRAWINGS

An illustrative and presently preferred embodiments of the present invention is shown in the accompanying drawings in which:

FIG. 1 illustrates a perspective view of a z-pin defining three radially extending flange sections which are arcuately configured at its peripheral edge;

FIG. 2 illustrates plurality of z-pins before being embedded into a first layer and a second layer;

FIG. 3 illustrates plurality of z-pins embedded into the first and second layers, with at least one of the z-pins having its flange sections embedded therein at least a depth of a width of the flange section;

FIG. 4 illustrates pluralities of z-pins embedded into the first and second layers, and the z-pins embedded therein are embedded into an intermediate strip, with the z-pins embedded into the first layer offset in relation to the z-pins embedded into the second layer;

FIG. 5 illustrates a z-pin embedded within the first and second layer with its longitudinal axis aligned with an applied force;

FIG. 6 illustrates a plurality of nubs configured as z-pins and unitary with the second layer before the nubs are embedded into the first layer;

FIG. 7 illustrates the plurality of nubs embedded into the first layer;

FIG. 8 illustrates one z-pin having three flange sections wherein the middle flange section has a cylindrical contour at its peripheral edge and the outer flange sections are arcuately contoured at its peripheral edge;

FIG. 9 illustrates a z-pin having a hour glass configuration; and

FIG. 10 illustrates the z-pin of FIG. 9 embedded into the first and second layers via a channel.

### DETAILED DESCRIPTION OF THE INVENTION

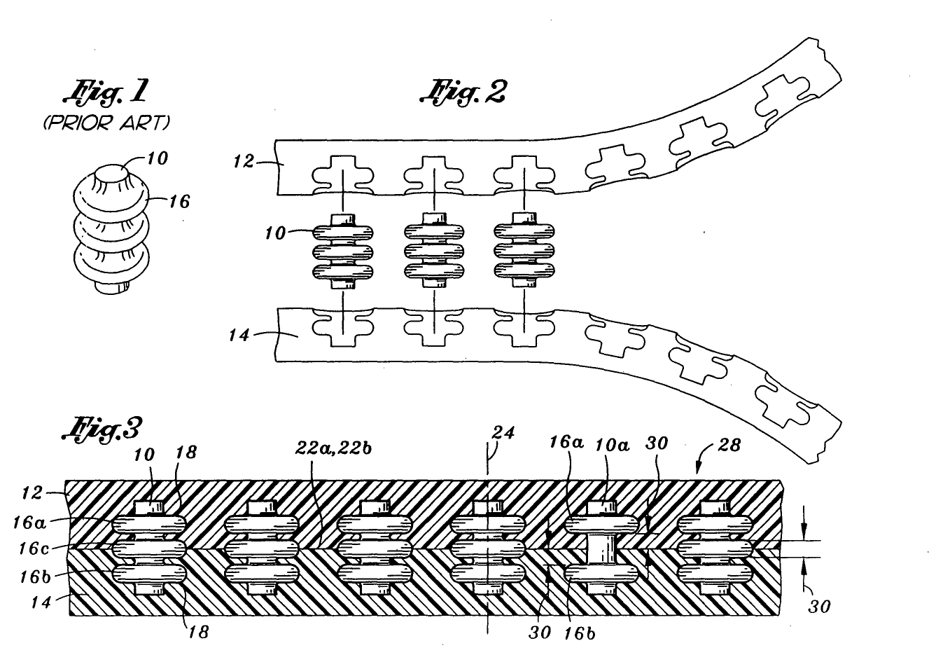

FIGS. 1-10 are for the purposes of illustrating the preferred embodiments of the present invention and not for limiting the same. The preferred embodiments of the present invention, as will be discussed below and as discussed in the summary of the invention, is generally related to z-pins 10 having a unique configuration. For example, the z-pins 10 may have a cylindrical middle flange section 16 so as to evenly distribute shearing forces. The present invention is additionally generally related to the position of the z-pins 10 within attached layers 12, 14, the orientation of the z-pins 10 in relation to an applied force, and a strip 20 to allow the attachment of a wide selection of materials from which the first and second layers 12, 14 may be manufactured.

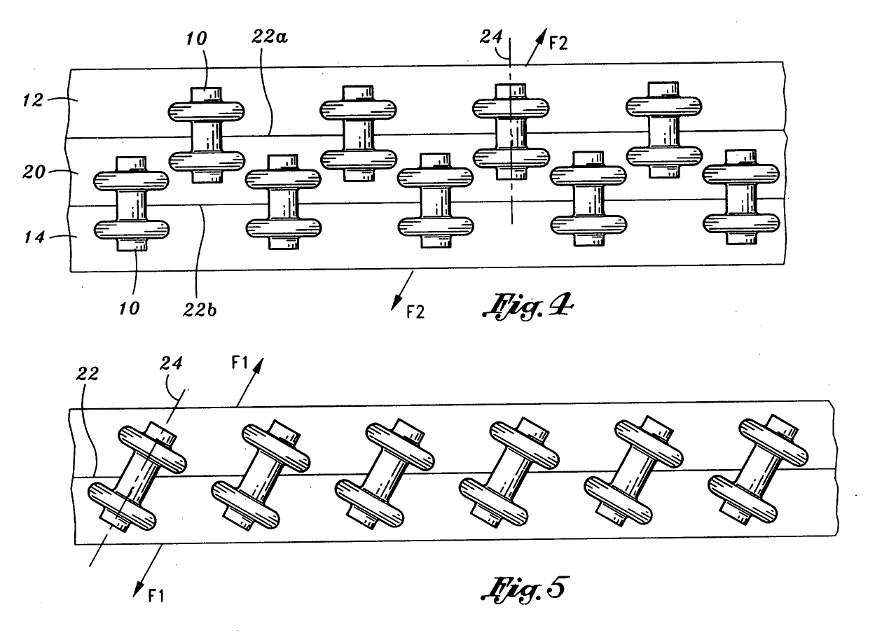

The following is a brief discussion of the z-pins 10 and its relationship to the two attached layers 12, 14. Generally, FIG. 1 illustrates a z-pin 10 which has three flange sections 16. FIG. 2 illustrates the z-pins 10 before it 10 is embedded into first and second layers 12, 14, and subsequently, FIG. 3 illustrates the z-pins 10 once they are embedded into the first and second layers 12, 14. The flange sections 16 of the z-pin 10 may be radially extending and have arcuately contoured peripheral edges. At least one of the flange sections 16a of the z-pin 10 may be embedded into the first layer 12, and at least one of the flange sections 16b of the z-pin 10 may be embedded into the second layer 14. The first and second layers 12, 14 may have a mating surface 18 which is a portion of a surface of the first or second layers 12, 14 in contact with the radially extending flange sections 16 of the z-pins 10.

Referring now to FIG. 4, a strip 20 is shown which is used to attach the first and second layers 12, 14. The attachment of the first and second layers 12, 14 as shown in FIG. 4 is different compared to the attachment of the first and second layers 12, 14 shown in FIG. 3. In particular, FIG. 3 illustrates a plurality of z-pins 10 embedded into the first layer 12 which are subsequently embedded into the second layer 14. In FIG. 4, the plurality of z-pins 10 embedded into the first layer 12 are not subsequently embedded into the second layer 14. Rather, they are embedded into the strip 20, and a plurality of z-pins 10 are embedded into the second layer 14 which are subsequently embedded into the strip 20. In this way, the plurality of z-pins 10 which are embedded into the first layer 12 and the plurality of z-pins 10 which are embedded into the second layer 14 are subsequently embedded into the common strip 20 to thereby attach the first and second layers 12, 14.

The advantage of the strip 20 is that a wide range of materials may be attached to each other. For example, the material of the first layer 12 may be of a chemically incompatible material compared to the material of the second layer 14. In this way, the intermediate strip 20 may isolate the chemical reactivity between the first and second layers 12, 14. Whereas, in the prior art, the two incompatible materials of the first and second layers 12, 14 could not be attached to each other, now, the two incompatible materials may be attached to each other. As will be discussed below, the use of various materials in the manufacture of attaching the first and second layers 12, 14 is advantageous. For example, the failure mode of the attached first and second layers 12, 14 may controlled such that failure of the attachment between the first and second layers 12, 14 may be at the z-pins 10 through failure of the z-pin 10 and not at the interface surface 22 of the attached layers 12, 14 through delamination. The failure of the attached first and second layers 12, 14 may be preferable at the z-pin 10 because the z-pin 10 may be more easily replacable compared to the layers 12, 14.

By adding the strip 20 between the first and second layers 12, 14, the volume of the attached first and second layers 12, 14 is increased by the thickness of the strip 20 because the strip 20 must encapsulate the portion of the z-pin 10 which protrudes from the first and second layers 12, 14. In this regard, the thickness of the strip 20 may be greater than the sum of the heights of the z-pins 10 externally protruding from respective interface surfaces 22a, 22b of the first and second layers 12, 14. Alternatively, the thickness of the strip 20 may be less than the sum of the heights of the protruding z-pins 10 from respective interface surfaces 22a, 22b of the first and second layers 12, 14. This embodiment which is illustrated in FIG. 4 shows the z-pins 10 embedded within the first layer 12 offset from the z-pins 10 embedded within the second layer 14 so as to form a more compact attached first and second layers 12, 14.

In another aspect of the present invention, a longitudinal axis 24 of the z-pins 10 used to attach the first and second layers 12, 14 may be aligned with an applied force “F” which acts upon the first and second layers 12, 14. As a preliminary matter, definitionally, the longitudinal axis 24 is located centrally along the length of the z-pin 10, and the applied force is the sum of all forces acting upon the first and second layers 12, 14. The alignment between the applied force and the longitudinal axis 24 of the z-pin 10 aids in controlling the failure mode of the attachment between the first and second layers 12, 14 by ensuring that the summation of forces acting on the z-pin 10 is only in tension which is preferable over other forces such as torsion and moment. FIG. 5 illustrates z-pins 10 with its longitudinal axis 24 in alignment with the applied force “F1.” In particular, the applied force “F1” acts upon the first and second layers 12, 14 at an angle which is 70° from the interface surfaces 22a, 22b of the first and second layers 12, 14, and accordingly, the longitudinal axis 24 is also oriented within the first and second layers 12, 14 to be at an angle which is 70° from the interface surfaces 22a, 22b of the first and second layers 12, 14. As such, the z-pin 10 may experience only a tensile force.

If the plurality of z-pins 10 had its longitudinal axis 24 perpendicular to the interface surfaces 22 of respective first and second layers 12, 14, as shown in FIG. 4, and the first and second layers 12, 14 are subjected to a force “F2” at an angle of 70° with respect to the interface surfaces 22 of the first and second layers 12, 14, then the plurality of z-pins 10 would be subjected to a variety of forces in addition to the tension force such as a shearing force, and a torsion force. Hence, the z-pins 10 embedded within the first and second layers 12, 14 may fail in other modes such as in shear, torsion or moment, whereas, the z-pins 10 having its longitudinal axis 24 aligned with the direction of the applied force “F” may fail only in tension. As such, the z-pins 10 having a longitudinal axis 24 aligned with the direction of the applied force have a greater degree of predictability and controllability compared to z-pins 10 having a longitudinal axis 24 misaligned with the direction of the applied force “F” subjected upon the first and second layers 12, 14.

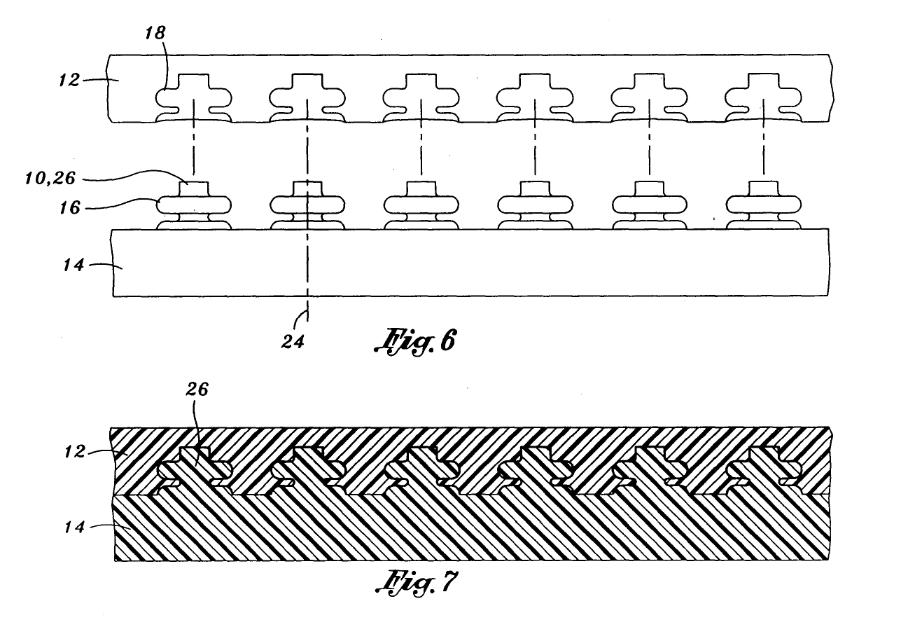

In another aspect of the present invention, instead of a separate and distinct z-pin 10 which attaches the first and second layers 12, 14, unitary nubs 26 may be formed as part of the either the first or second layer 12, 14, as shown in FIGS. 6 and 7. In FIG. 6, the nubs 26 are formed as part of the second layer 14 which is a matter of convenience in explaining the various aspects of the present invention. More particularly, the first layer 12 may have mating surfaces 18 to receive the nubs 26, and the second layer 14 may be manufactured as a unitary structure with the nubs 26. The second layer 14 may have a plurality of nubs 26 with each nub 26 having at least one radially extending flange section 16. In this regard, the nubs 26 may be embedded into first layer 12 and received by the mating surfaces 18 of the first layer 12 through the various manufacturing processes described in this specification. Additionally, the longitudinal axis 24 of the nubs may be aligned with the applied force.

Still yet in another aspect of the present invention, the density of the z-pin material may be selected to be lower than the density of the materials of the first and second layers 12, 14 so as to lower the overall density and weight of the attached first and second layers 12, 14 and/or strip 20 compared to first and second layers 12, 14 attached through other means such as welding or adhesive bonding. The advantage of making a structure 28 (i.e., attached first and second layers 12, 14) lighter is obvious for many reasons such as reduced fuel consumption if the structure 28 was used on an airplane or car with the added benefit of being strong.

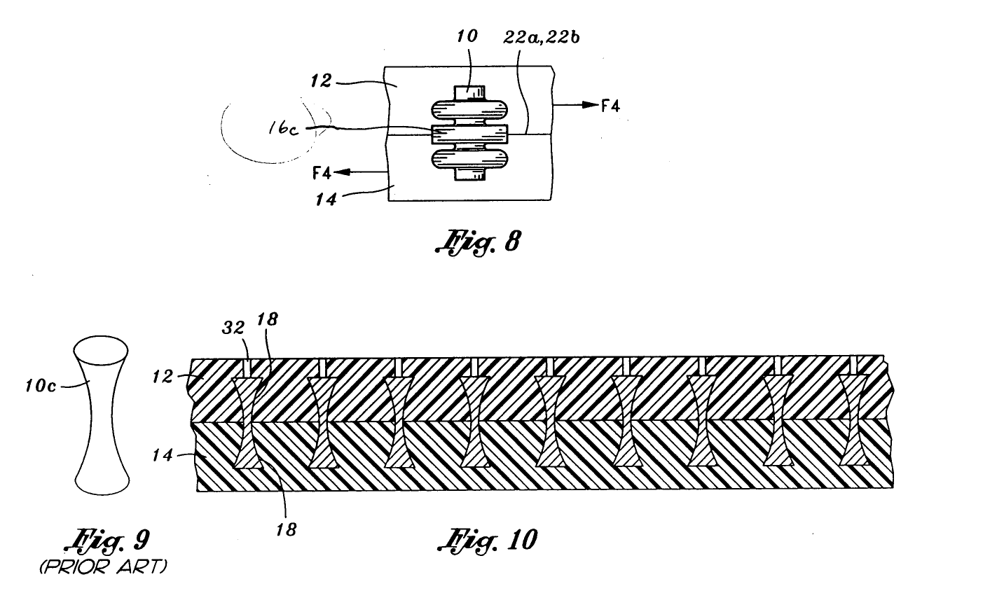

In another aspect of the present invention, the shape of the flange sections 16 of the z-pin 10 may be re-contoured so as to more evenly distribute a shearing force that may be loaded onto the z-pin 10. In particular, the middle flange section 16 may have a cylindrically contoured peripheral edge as shown in FIG. 8 instead of an arcuately contoured peripheral edge as shown in FIG. 3. In FIG. 3, the z-pin 10 is embedded within first and second layers 12, 14 wherein the z-pin 10 has three radially extending flange sections 16a, 16b, 16c. The middle flange section 16c is shown as being disposed at the interface surfaces 22a, 22b of the first and second layers 12, 14. The middle flange section 16c is arcuately contoured at its peripheral edge and defines a width 30. In contrast, FIG. 8 illustrates a z-pin 10 embedded within the first and second layers 12, 14 where the middle flange section 16c of the z-pin 10 is cylindrically configured at its peripheral edge and the middle flange section 16c is disposed at the interface surfaces 22a, 22b of the first and second layers 12, 14. In this regard, this z-pin 10 may bear a greater shear force “F4” compared to a z-pin 10 embedded within the first and second layers 12, 14 wherein the middle flange section 16c of the z-pin 10 is accurately contoured at its peripheral edge. The reason stems from the shape of the middle flange section 16c. If middle flange section 16c is arcuately contoured then the first and second layers 12, 14 may slip over the arcuate configuration when a shear force is applied to the first and second layers 12, 14. In contrast, if the middle flange section 16c is cylindrically configured then the first and second layers 12, 14 will exert an evenly distributed force on the cylindrical surface which is capable of bearing a greater shear force compared to the former arcuately configured flange section 16.

In another aspect of the present invention, the depth to which the flange sections 16 are embedded within the first and second layers 12, 14 may be controlled so as to control the failure mode of the attachment between the first and second layer 12, 14. Preferably, the flange sections 16 of the z-pin 10 are embedded within the first and second layers 12, 14 at least to the width 30 of the flange section 16. This aspect of the present invention is illustrated in FIG. 3 which illustrates a z-pin 10a having two radially extending flange sections 16a, 16b with each flange section 16a, 16b being embedded within respective first and second layers 12, 14. Preferably, each flange section 16a, 16b is embedded within respective first and second layers 12, 14 to a depth equivalent to the width 30 of the flange section 16. In this regard, the first and second layers 12, 14 have a greater amount of material which retains the flange sections 16a, 16b within the first and second layers 12, 14.

In another aspect of the present invention, the number of flange sections 16 embedded within the first and second layers 12, 14 may be adjusted as a function of the strengths of the first and second layers 12, 14. As a preliminary matter, definitionally, the strengths of the first and second layers 12, 14 in conjunction with the z-pin 10 may be associated with a pull out force. The pull out force is the force required to pull the z-pin 10 out from the first or second layers 12, 14 through delamination of the first or second layers. Additionally, the z-pin 10 has an ultimate and/or yield strength. If the ultimate or yield strength of the z-pin 10 is less than the pull out force of the first and second layers 12, 14, then the attached first and second layers 12, 14 will tend to fail at the z-pin 10 itself. If the ultimate or yield strength of the z-pin 10 is greater than the pull out force of the first and second layers 12, 14, then the attached first and second layers 12, 14 will tend to fail at the first or second layers 12, 14 with the lower pull out force.

If the preferred mode of failure is at the z-pin 10, then additional flange sections 16 formed on distal ends of the z-pin 10 may be embedded within the first and second layers 12, 14 to increase the pull out force of the first and second layers 12, 14 to a level greater than a force required to break the z-pin 10. Alternatively, if the preferred failure mode is at the first layer 12, then the number of flange sections 16 embedded within the first layer 12 may be reduced such that the pull out force of the z-pin 10 from the first layer 12 is lower than the pull out force of the z-pin 10 from the second layer 14 and is lower than the force required to break the z-pin 12.

In another aspect of the present invention, the z-pin material may be selected to have a unique physical characteristic in relation to the physical characteristics of the materials from which the first and second layers 12, 14 are manufactured. For example, the first layer 12, second layer 14 and z-pin 20 may be manufactured with materials that have different or equivalent coefficients of thermal expansion (CTE), hardness, melting temperature, chemical reactivity and density. By way of example and not limitation, to achieve the various unique physical relationships, the first layer 12, second layer 14, strip 20 and z-pin 10 may be manufactured from materials selected from the group consisting of plastic, composite, metallic, ceramic, graphite epoxy, thermosetting material and thermoplastic material.

In relation to the CTE relationship, the CTE of the z-pin 10 may be less than the CTE of the first and second layers 12, 14. In this regard, when the structure 28 comprising the z-pin 10, first layer 12 and second layers 14 is heated, the z-pin 10 will expand at a slower rate compared to the rate of expansion of the first and second layers 12, 14. As such, the z-pins 10 will not exert a force on the mating surface 18 of the first and second layers 12, 14. Preferably, the CTE of the z-pin 10 is equal to the CTE of the first and second layers 12, 14. In this regard, when the structure 28 is heated, the z-pins 10 will expand or contract at the same rate compared to the first and second layers 12, 14. As such, the z-pins 10 maintain a constant pressure between the z-pins and mating surfaces of respective first and second layers.

In relation to the hardness relationship, the hardness of the z-pin 10 may be less than the hardness of the first and second layers 12, 14. In this way, the z-pin 10 may be drilled out when there is a failure in the z-pin 10 and there are remains of the z-pin 10 within the mating surface 18 of the first and second layers 12, 14.

In relation to the melting temperature relationship, the melting temperature of the z-pin 10 may be greater than the melting temperature of the first and second layers 12, 14. In this regard, the z-pin 10 may be embedded into the first and second layers 12, 14 through various manufacturing processes which may use heat. For example, the z-pin 10 may be embedded into the first layer 12 through investment casting. In investment casting, the z-pin(s) 10 may be embedded in the investment with a portion of the z-pin 10 protruding into the cavity after the wax has been removed therefrom. In this way, the z-pin(s) 10 may be embedded within the layer 12, 14 after the investment material is removed from the casting or layer 12, 14. Alternatively, the z-pin 10 may be embedded into the first layer 12 through methods such as injection, resin transfer and resin infusion.

In relation to the chemical reactivity relationship, the chemical reactivity of the z-pin 10 with various chemicals may be different compared to the chemical reactivity of the first and second layers 12, 14 with those chemicals. In this regard, the z-pin 10 may be embedded into the first and second layers 12, 14 through various manufacturing processes which may use a chemical reaction such as resin transfer molding.

Referring now to FIG. 9, the same illustrates a z-pin 10c as described in the '593 Patent. The z-pin 10c may be embedded into first and second layers 12, 14 by injecting the z-pin material in a liquid form through a channel 32 formed in one of the layers 12, 14. In FIG. 10, the channel 32 is formed in the first layer 12. The first and second layers 12, 14 have mating surfaces 18 configured in the shape of the z-pin 10c shown in FIG. 9. The first and second layers 12, 14 are attached to each other and the mating surfaces 18 of the first and second layers 12, 14 are aligned with each other. The z-pin material in liquid form in injected into the channel 32 and allowed to fill the mating surfaces 18 of the first and second layers 12, 14. Thereafter, the liquid z-pin material may be solidified to form the z-pin 10c within the first and second layers 12, 14. This same technique may be used to attached the first and second layers 12, 14 with z-pins 10 of various shapes and sizes such as the shape of the z-pins 10 shown in FIG. 3.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

1. A structure comprising:
a. a first layer;
b. a second layer adjacent to the first layer; and
c. at least one z-pin embedded within the first and second layers to attach the first and second layers, the z-pin embedded therein defines a pull out force with respect to the first layer less than a pull out force with respect to the second layer, each z-pin having at least two radially extending flanges with at least one flange embedded within the first layer to greater depth compared to a depth to which the flange section is embedded within the second layer to compensate for the lower pull out force of the z-pin from the first layer compared to the pull out force of the z-pin from the second layer.

2. The structure of claim 1 wherein each layer and z-pin defines a melting temperature, and the melting temperature of the z-pin is greater than the melting temperatures of the layers to allow the z-pin to be casted into the first and second layers.

3. The structure of claim 1 wherein the first layer is manufactured from material selected from the group consisting of metal, ceramic, organic material, inorganic material, organic material with reinforcement fibers, organic material without reinforcement fibers, inorganic material with reinforcement fibers, inorganic material without reinforcement fibers, ceramic, and graphite epoxy.

4. The structure of claim 1 wherein the second layer is manufactured from material selected from the group consisting of metal, ceramic, organic material, inorganic material, organic material with reinforcement fibers, organic material without reinforcement fibers, inorganic material with reinforcement fibers, inorganic material without reinforcement fibers, ceramic, and graphite epoxy.

5. The structure of claim 1 wherein the first and second layers are manufactured from identical materials.

6. The structure of claim 1 wherein the z-pins embedded within the first layer have a greater number of flange sections embedded therein compared to a number of flange sections embedded within the second layer to compensate for the lower pull out force of the z-pin from the first layer compared to the pull out force of the z-pin from the second layer.

7. The structure of claim 1 wherein the z-pin has at least three radially extending flanges with a center flange having a cylindrical peripheral edge disposed at interface surfaces of the first and second layers to evenly distribute shearing forces created by the first and second layers on the center flange.

8. The structure of claim 1 wherein an applied force is subjected on the structure and each z-pin defines a longitudinal axis aligned with the applied force to maximize the load carrying ability of the z-pin.

9. The structure of claim 1 wherein the first layer, second layer and z-pin define respective densities, and the z-pin density is lower than the densities of the first and second layers to reduce a density of the structure with z-pins compared to a density of the structure without z-pins.

10. The structure of claim 1 wherein the first layer, second layer and z-pin define respective hardnesses, and the z-pin hardness is lower than the hardness of the first and second layers to allow the z-pin to be removed from the first and second layers.

11. The structure of claim 1 wherein the first layer, second layer and z-pin define respective coefficients of thermal expansion, and the coefficients of thermal expansion of the first layer, second layer and z-pin(s) may be equal to limit stresses between the z-pin and respective first and second layers.

12. The structure of claim 1 further comprising a strip disposed between the first and second layers wherein the strip has embedded therein the z-pin flanges protruding from respective interface surfaces of the first and second layers.

13. A structure comprising:
a. a first layer defining an interface surface and having at least one depression, each depression configured as a female mating flange of a z-pin;
b. a second layer defining an interface surface with at least one nub being unitary with the second layer, each nub configured as at least one flange of the z-pin.

14. The structure of claim 13 wherein each layer defines a melting temperature and the melting temperature of the second layer is greater than the melting temperature of the first layer to allow the nub to be casted within the depression of the first layer.

15. The structure of claim 13 wherein the first layer is manufactured from material selected from the group consisting of metal, ceramic, organic material, inorganic material, organic material with reinforcement fibers, organic material without reinforcement fibers, inorganic material with reinforcement fibers, inorganic material without reinforcement fibers, ceramic, and graphite epoxy.

16. The structure of claim 13 wherein the second layer is manufactured from material selected from the group consisting of metal, ceramic, organic material, inorganic material, organic material with reinforcement fibers, organic material without reinforcement fibers, inorganic material with reinforcement fibers, inorganic material without reinforcement fibers, ceramic, and graphite epoxy.

17. The structure of claim 13 wherein the first layer defines a first layer strength and the second layer defines a second layer strength stronger than the first layer strength, and a nub embedded within the first layer defines a pull out force as a function of a number of flanges embedded therein and the first layer strength, and the nub unitary with the second layer defines a pull out force as a function of the second layer strength, the nub having a sufficient number of flanges such that the pull out force of the nub embedded within the first layer is less than the pull out force of the nub for directing a failure mode of the structure to the first layer.

18. The structure of claim 13 wherein the nub has a base flange configured as a cylindrical peripheral edge, and the base flange is disposed at interface surfaces of the first and second layers to evenly distribute shearing forces created by the first and second layers on the base flange.

19. The structure of claim 13 wherein the first layer and second layer define respective coefficients of thermal expansion, and the coefficients of thermal expansions of the first and second layers are equal to limit stresses between the nub and the first layer.

20. A method for limiting delamination between attached first and second layers, the method comprising step a) of embedding a plurality of z-pins into an interface surface of the first layer, and embedding a plurality of z-pins into an interface surface of the second layer, each z-pin having at least two radially extending flanges, at least one flange section being embedded into respective first and second layers, and at least one flange sections protruding externally from the interface surfaces of respective first and second layers.

21. The method of claim 20 further comprising step b) of inserting the flanges protruding externally from the interface surfaces of the first and second layers into the interface surfaces of the second and first layers, respectively.

22. The method of claim 20 further comprising step b) of inserting the flanges protruding externally from the interface surfaces of the first and second layers into a strip.

23. The method of claim 22 wherein the plurality of z-pins embedded into the first and second layers have z-pins embedded within the first layer which are offset with the z-pins embedded within the second layer.

24. A method of embedding z-pins within first and second layers, the method comprising:
a. forming female flange sections within the first and second layers with a channel connected to each of the female flange sections;
b. aligning the female flange sections of the first and second layers to each other;
c. filling liquid z-pin material into the aligned female flange sections of the first and second layers through the channel; and
d. solidifying the liquid z-pin material.
